(19) United States
(12) Patent Application Publication
(10) Pub. No.: US 2002/0183420 A1
(43) Pub. Date: Dec. 5, 2002

(54) Composition

(76) Inventor: Paul Ralph Fordham, Bedfordshire (GB)

Correspondence Address: Christopher J Fildes, Fildes & Outland, Suite 2, 20916 Mack Avenue, Grosse Pointe Woods, MI, 48236, US

(21) Appl. No.: 10/111,525

(22) PCT Filed: Dec. 1, 2000
(86) PCT No.: PCT/GB00/04591

(30) Foreign Application Priority Data
Dec. 3, 1999 (GB) 99285157

(51) Int. Cl. C09D 5/29

(52) U.S. Cl. 523/171

(57) ABSTRACT

A method of painting comprising mixing a composition, applying the composition to a surface and stippling the so-applied composition to produce a stone effect, wherein the composition comprises a surfactant.

### DESCRIPTION

This invention relates to a paint composition and, more specifically, to a method of applying a composition to produce a desired effect.

Interior decoration is notoriously susceptible to the vagaries of fashion and, consequently, fashion determines which finishes are considered desirable upon a wall surface. Over the past thirty years or so, a variety of new materials have been brought to market to satisfy the public's demand for fashionable finishes for their wall surfaces. Indeed, a variety of finishes are now available both to the do-it-yourself “expert” and to the skilled tradesman.

For example, it is now well known that wall surfaces may be finished with materials such as artex, which provide the wall with a textured look and feel. Furthermore, new wallpaper designs are continually being produced and paint manufacturers are ceaselessly attempting to invent new paint colours and finishes for a variety of surfaces.

There is a demand, from one time to another for natural materials within the home, such as animal prints, wood or even stone. However, certain finishes, such as these, are notoriously difficult to provide due to the nature of the desired look.

Whilst wallpaper can be used to provide these finishes, it is often associated with its own particular difficulties. For example, removing the old wallpaper, sanding down the walls, or re-plastering if necessary, and finally applying the wallpaper, which can be an arduous and time-consuming operation.

Such problems are also found with paint. For example, if the paint upon a surface is damaged, the whole surface often requires re-painting as it is almost impossible to mix the new paint to the same colour as the old damaged paint.

Paint can obviously be used by a skilled artist to provide most, if not all looks for a surface. However, it has been used, by the skilled tradesman, in an attempt to provide a natural stone-look finish for some time, albeit with disappointing results.

In order to provide a stone-effect finish, the tradesman conventionally brushes two coats of a base paint, such as quick drying acrylic eggshell, which has a neutral colour, onto a wall and, once these coats are dry, applies an acrylic glaze or, alternatively an oil based glaze on an oil base coat. This glaze is then stippled using a stipple brush. The finished effect, which is somewhat haphazard in appearance, provides a broken surface of glaze through which the base colour shows. The finish has a fibrous look and feel, due to the action of the stipple brush. In fact, unless the background paint and the glaze are mixed and applied correctly, the effect does not really give the impression, or look, of stone at all. Moreover, even when the glaze and paint have been diligently mixed and applied the results are often disappointing.

Due to the nature of the glaze, and the environments in which it is used, both acrylic and oil-based glazes become tacky to the touch, or “set-up”, very quickly and, consequently this task is usually a two-man job, the first to apply the glaze and the second to stipple it. It has also been established that oil-based glazes can “yellow” with time, this discoloration is unsightly and gives an aged appearance somewhat prematurely.

Accordingly, it is an object of the present invention to provide a method of applying a paint composition so as to provide a desired, stone-effect finish and to at least substantially obviate the above-identified problems and imperfections in the look of the finished surface. It is a further object of the invention to provide a composition which yields a hard-wearing, stone-effect, finish and which can be applied by an individual.

According to a first aspect of the invention, there is provided a method of painting comprising mixing a composition, applying the composition to a surface and stippling the so-applied composition to produce a stone effect, wherein the composition comprises a surfactant.

Preferably, the surface is pre-coated with a base coat, such as a quick dry acrylic eggshell.

The method may further comprise separating the surface into cells, which may be regular or irregular, and stippling the composition so as to produce a different stone-effect in each.

According to a second aspect of the invention there is provided a stone-effect paint composition comprising a surfactant, wherein the composition is such that once it has been applied to a wall and stippled it dries to give a stone effect.

Additionally, the composition comprises a glaze and water, the glaze preferably comprises a vinyl emulsion matt glaze or an acrylic glaze, for example an acrylic scumble “slow-set” glaze. The composition may further comprise a colourant, such as a universal colourant.

Preferably, the ratio of glaze to water is in a range from 1.6:1 to 0.9:1, and more preferably the ratio of glaze to water is 1.25:1. The amount of surfactant present in the composition is preferably in a range from 5 to 20 (v/v) %, more preferably in a range between 8 and 15 (v/v) % and more preferably still 10 (v/v) %.

Preferably the amount of colourant added to the composition is in a range from 1 to 2 (v/v) %, and more preferably 1.25 (v/v) %.

Preferably, the surfactant is a liquid soap, such as washing-up liquid but more preferably a sodium salt of one or more fatty acids, such as palmitic, stearic, oleic, palmitoleic, linoleic, linolenic or risenoleic acid.

The method of applying the paint composition and the composition in accordance with the various aspects of the invention will now be described by way of example only with reference to the accompanying drawings and the following Examples.

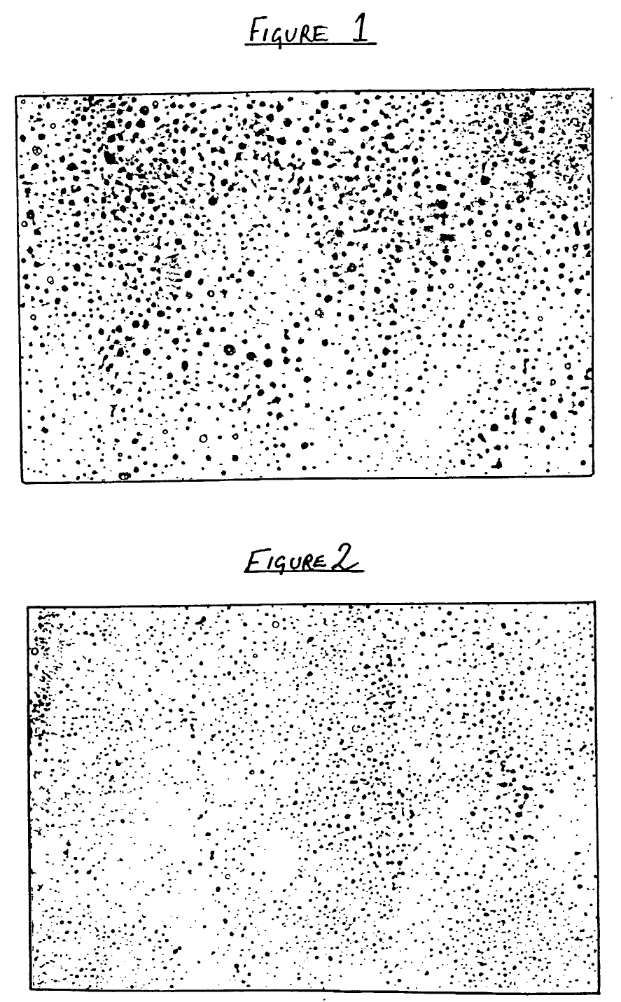

FIG. 1 shows the effect produced by composition 5 of the examples; and

FIG. 2 shows the effect produced by composition 5 following further stippling.

In all of the Examples, the glaze was mixed with water and surfactant, such as a liquid soap or at least one of the fatty acid sodium salts identified above, and stirred to provide a homogenous liquid. A surface was prepared by applying at least two coats of base coat, leaving it to fully dry, and then taping-off the area which it was intended to paint, to define cells, as is well known in the art. The composition was then applied to the surface with a regular paint-brush and, once-applied, stippled using a stipple brush. A dry rag may be used to remove an excess of the composition whilst stippling, if required.

TABLE 1

| | | | | Touch Dry | Resilience @ |
|---|---|---|---|---|---|
| Number | Glaze^{(a)} | Water^{(a)} | Surfactant^{(a)} | Time/min ^{(b)} | 100 min ^{(c)} |
| 1 | 3 | 2 | 1 | 20 | 20 |
| 2 | 3 | 3 | 1 | 20 | 20 |
| 3 | 4 | 3 | 1 | 20 | 40 |
| 4 | 4 | 4 | 1 | 20 | 40 |
| 5 | 5 | 4 | 1 | 20 | 50 |
| 6 | 5 | 5 | 1 | 20 | 50 |
| 7 | 6 | 5 | 1 | 20 | 50+ |
| 8 | 6 | 6 | 1 | 20 | 50+ |

^{(a)} The listed amounts are the number of parts of each which were mixed in the composition.
^{(b)} The Touch Dry Time is the time taken for the stippled composition to become touch dry.
^{(c)} Resilience is measured as the number of hard strokes taken to remove at least some of the composition from the surface 100 minutes after application.

### EXAMPLE 1

Two base coats of quick dry acrylic eggshell were applied to a wall and left to dry. The wall was then separated into rectangular cells by taping-off as is well known in the art. Composition I was then mixed, and a small amount (≈1.3 (v/v) %) of universal cream colourant was added. The glaze was a vinyl matt emulsion glaze.

The composition was applied to one cell of the dried wall with a regular paint-brush and then, whilst wet, stippled using a moistened S222 No. 7 Setola Brush. The composition, upon stippling, begins to froth and, whilst it dries, individual circular spots begin to form on the surface. The colourant partitions into the spots to provide a random array of darker spots on a lighter background.

This composition was touch dry within 20 minutes, and could sustain 20 strokes in the resilience test. The surface was washable three hours after application.

### EXAMPLE 2

Two base coats of quick dry acrylic eggshell were again applied to a wall and left to dry. The wall was then separated into rectangular cells by taping-off as is well known in the art. Composition 5 was then mixed, using a vinyl emulsion matt glaze, and a small amount (≈1.25 (v/v) %) of universal blue/black colourant was added.

The same procedure as for Example 1 was used, except a two-row stipple brush was used to apply the composition. The composition was touch dry within 20 minutes and resisted 50 strokes in the resilience test conducted 100 minutes after application.

The effect produced is shown in FIG. 1. As can be seen, the effect is of an array of darker spots upon a lighter background. The irregularity of the spot size and distribution all combines to give a so-painted surface the appearance of stone. To alter the size and distribution of the individual spots, the same mixture is applied and it is stippled for a different time. For example, and as shown in FIG. 2, the same composition was applied to the surface and the effect has been altered by stippling for twice as long. This divides the spots and in so-doing alters the appearance and “texture” of the stone effect.

### EXAMPLE 3

Composition 5 was mixed, except using an acrylic emulsion glaze and applied with a two-row stipple brush. Again the mixture was touch dry within 20 minutes and resisted 50 strokes in the resilience test.

The effect can be altered using a variety of factors. For example, the amount of the composition which is applied to the surface, the amount of water in the mixture and the type of stipple brush used all affect the type of dots and the size thereof Indeed, the longer that the mixture is stippled for the smaller the dots and the “grainier” the finish as described above. If too much water is used in a composition the finished effect is one of large spots and no texture, whereas if too little is used the finished effect has no spots and is all textured.

Indeed, with a regular stipple stroke one can expect a random array of spots, each of which will be of the order of up to 4 mm in diameter. By re-stippling the same area, the spot diameter can be decreased and the number of spots is concomitantly increased. This obviously provides a varied finish and can be used to provide a natural look, particularly if the composition is applied to a surface which has been divided into cells, with each cell having a slightly different effect.

The amount of water added also affects the drying time of the composition and the adhesion of the composition to the background base coat. For example, as the ratio of glaze to surfactant increases from 3:1 to 6:1 (composition 1 to 9) the resilience of the finished surface increases from 20 to 50+. However, as the amount of water increases for a particular ration of glaze to surfactant, the resilience decreases and the drying time increases.

The composition may also be applied onto a base-coat of oil-based eggshell paint. The finish is spongeable within eight hours of application although the resilience is somewhat less than that afforded by an acrylic bas-coat, however, it provides a richer finish and a different stone-like design. Thus such a base-coat may be used to provide varying effects, or in an area where it is less likely to suffer damage.

Due to the drying time of the composition it must be worked quickly and efficiently into the desired part of the wall. However, due to the nature of the composition, and the finish provided thereby, individual cells will not have an identical look. This factor only enhances the stone-effect impression given by the composition.

In practice, the surface to which the composition is to be applied will have been previously painted with the desired base colour, and will then be separated into a number of cells. The size of the cells will be chosen so as to replicate the desired block-size of the stone effect; a usual area to be covered may be half a square metre, for example.

In this fashion, individual disparate blocks may be completed with one particular composition, stippled to provide uniform spots therein, whilst adjacent blocks can be completed with a different composition, or the same composition stippled so as to provide a different spot size. The overall affect, once the tape has been removed and the cells have dried, will be of an array of different stone blocks.

However, and if desired, an effect can be attained whereby the blocks are all similar, simply by carefully mixing the composition and applying it in a uniform manner.

Imperfections in the structure of the surface to which the composition is applied, act to improve the texture and look of the finish. Conventionally, such imperfections are painted on after the stone-effect paint has dried, whereas with this method they are incorporated to enhance the impression.

This method allows for a single person to both apply the composition and to stipple it thereby providing the stone effect. In contrast to conventional techniques, in which the glaze “goes off” very quickly, or in which an artisan's skill is required, this method is easier to use by an individual and, more importantly, it affords an improved stone-effect finish than that provided conventionally. Furthermore, the finish, when applied to an acrylic base-coat, is washable after about three hours and the brushes are cleaned a great deal easier after using the inventive composition than after using conventional glazes.

As discussed above, a liquid soap may be used as the surfactant in the above Examples but more particularly a sodium salt of one or more fatty acids, such as palmitic, stearic, oleic, palmitoleic, linoleic, linolenic and risenoleic acids, may be used as the surfactant.

1. A method of painting comprising mixing a composition, applying the composition to a surface and stippling the so-applied composition to produce a stone effect, wherein the composition comprises a surfactant.

2. A method according to claim 1, wherein the surface is pre-coated with a base coat.

3. A method according to claim 2, wherein the base-coat is a quick dry acrylic eggshell.

4. A method according to claim 1, 2, or 3 further comprising separating the surface into cells prior to application, and stippling the composition so as to produce a different stone-effect in each.

5. A method according to claim 4, wherein the cells are regular.

6. A method according to any preceding claim, wherein the composition comprises a glaze and water.

7. A method according to claim 6, wherein the glaze comprises a vinyl emulsion matt glaze.

8. A method according to claim 6, wherein the glaze comprises an acrylic glaze.

9. A method according to any preceding claim, further comprising adding a colourant to the composition prior to stippling.

10. A method according to claim 6 or any claim dependent thereon, wherein the ratio of glaze to water is in a range from 1.6:1 to 0.9:1.

11. A method according to claim 10, wherein the ratio of glaze to water is 1.25:1.

12. A method according to any preceding claim, wherein the amount of surfactant present in the composition is in a range from 5 to 20 (v/v) %.

13. A method according to claim 12, wherein the amount of surfactant is in a range between 8 and 15 (v/v) %.

14. A method according to claim 13, wherein the amount of surfactant is 10 (v/v) %.

15. A method according to claim 9 or any claim dependent thereon, wherein the amount of colourant added to the composition is in a range from 1 to 2 (v/v) %.

16. A method according to claim 15, wherein the amount of colourant added to the composition is 1.25 (v/v) %.

17. A method according to any preceding claim wherein the surfactant is a liquid soap, such as washing-up liquid.

18. A method according to any of claims 1 to 16, wherein the surfactant is a sodium salt of one or more fatty acids.

19. A method according to claim 18, wherein the fatty acid is palmitic, stearic, oleic, palmitoleic, linoleic, linolenic or risenoleic acid.

20. A stone-effect paint composition comprising a surfactant, wherein the composition is such that once it has been applied to a wall and stippled it dries to give a stone effect.

21. A composition according to claim 20 further comprising a glaze and water.

22. A composition according to claim 21, wherein the glaze comprises a vinyl emulsion glaze.

23. A composition according to claim 21, wherein the glaze comprises an acrylic glaze.

24. A composition according to any of claims 20 to 23, further comprising a colourant.

25. A composition according to any of claims 20 to 24, wherein the ratio of glaze to water is in a range from 1.6:1 to 0.9:1.

26. A composition according to claim 25, wherein the ratio of glaze to water is 1.25:1.

27. A composition according to any of claims 20 to 26, wherein the amount of surfactant present is in a range from 5 to 20 (v/v) %.

28. A composition according to claim 27, wherein the amount of surfactant is in a range between 8 and 15 (v/v) %.

29. A composition according to claim 28, wherein the amount of surfactant is 10 (v/v) %.

30. A composition according to claim 24 or any claim dependent thereon, wherein the amount of colourant is in a range from 1 to 2 (v/v) %.

31. A composition according to claim 30, wherein the amount of colourant is 1.25 (v/v) %.

32. A composition according to any claims 20 to 31, wherein the surfactant is a liquid soap, such as washing-up liquid.

33. A composition according to any of claims 20 to 31, wherein the surfactant is a sodium salt of one or more fatty acids.

34. A composition according to claim 33, wherein the fatty acid is palmitic, stearic, oleic, palmitoleic, linoleic, linolenic or risenoleic acid.
